(19) United States
(12) Patent Application Publication
(10) Pub. No.: US 2002/0032714 A1
(43) Pub. Date: Mar. 14, 2002

(54) Image control system, image control method and program for same

(76) Inventor: Yusuke Monobe, Fukuoka-ken (JP)

Correspondence Address: MCDERMOTT WILL & EMERY, 600 13TH STREET, N.W., WASHINGTON, DC, 20005-3096, US

(21) Appl. No.: 09/891,495

(22) Filed: Jun. 27, 2001

(30) Foreign Application Priority Data
Jun. 27, 2000 (JP) 2000-192268

(51) Int. Cl. G06F 9/00

(52) U.S. Cl. 709/100

(57) ABSTRACT

An image management system easy to switch to the server-client image management system and possible to operate as server-client image management system and standalone image management system with the user's operating procedures unified for the two systems. The image management terminal is provided with switchover control means for sending to an image management server image data and management information—managed within the image management terminal—according to the user's instructions, while the image management server is provided with switchover image registration means which registers with storage means image data and management information acquired from the image management terminal.

### FIELD OF THE INVENTION

The present invention relates to an image management system, image management terminal, image management server, image management method and program for the same for management of electronized image data.

### BACKGROUND OF THE INVENTION

With the spread of computers, documents used in the offices have been electronized and managed. That is, documents are stored and managed as electronized document data. Since such stored document data eliminate the need to use paper, it can be said that the system saves costs and is environment-friendly. Furthermore, since documents are stored as document data, the system has an advantage over the conventional paper-based document management in that it is possible to retrieve an object document by using a key word, for example, and to instantaneously pick out the needed document out of a vast amount of documents.

In recent years, furthermore, in addition to the document data, image data have been managed in the same way as the document data, that is, image data read through an input device such as a scanner are stored and managed electronized. The image data is usually larger than the document data in file size, yet the electronized image data management has been spreading. One of the reasons for the spread of the electronized image data management is the fact that data storage units have greatly increased in memory capacity in recent years.

There are two such image management systems.

One is a standalone image management system in which image data are personally stored and managed within a single computer. The other is a server-client image management system in which there is provided a server shared by a plurality of users and image data stored in the server are shared among client computers.

In the standalone image management system, the inputted image data are utilized personally by a user alone and can not be shared among a plurality of persons. But the system is relatively low in cost.

In the case of the server-client image management system, on the other hand, image data inputted by a user can be seen by other users. In other words, image data can be shared among a plurality of users. But the system is complicated in arrangement and management and is high in cost.

Such being the circumstances, an image management system is adopted in the following way in many cases. First, a standalone image management system is installed to store and manage image data on a small scale. And when image data need to be shared among plurality of users later, a server-client image management system is adopted.

But the standalone image management system and the server-client image management system are so constructed (offered) that they are units completely independent of each other. Therefore, when the standalone image management system is replaced with the server-client image management system, image data and information related to each image data have to be registered with the latter system all over again. That is, unlike the document data, the image data is not provided with information necessary for retrieval of the managed image data. Therefore, image data have to be managed in a special way or by adding to the image data key word information (text information) indicating a key word related to the image data, for example, so that the image data can be retrieved.

The problem is that when the image management systems are changed, it is impossible to coordinate the image data and information related to that image data by merely copying (moving) image data from clients to the server unlike in the case of a switchover of document management. It is necessary to register the image data and information related to the respective image data with the server-client image management system from the beginning.

It is also noted that the standalone image management system and the server-client image management system are offered as different systems. For this reason, the users have to learn the way of operating the server-client image management system, and thus a vast amount of labor is needed in a system switchover.

### SUMMARY OF THE INVENTION

In view of the prior art described above, the present invention has been proposed, and it is an object of the present invention to provide an image management system, image management terminals and an image management server, an image management method and a program for the same that make it easy to switch to a server-client image management system and can be used as a server-client image management system and a standalone image management system and which unifies the user's operating procedures for the two systems.

To effect the above objects, the present invention is provided with the following means.

That is, the present invention is based on an image management system that is formed of image management terminals and an image management server in which electronized image data are managed using management information to manage the image data. The image management terminal of the image management system is provided with image data managed within the image management terminal on instructions from the user and a switchover control means for sending to the image management server management information corresponding to the image data. The image management server is provided with a switchover image registration means that registers with a storage means image data and management information acquired from the image management terminal.

That arrangement in which there are provided a switchover control means and a switchover image registration means so as to eliminate the need to register image data again substantially saves labor needed in transferring image data and management information from the image management terminal to the image management server, that is, labor needed in a switchover from a standalone image management system to a server-client image management system.

Furthermore, the system may be so arranged that management information stored in the image management terminal is provided with sharing attribute information and that the switchover control means sends the image data and management information on the basis of the sharing attribute information.

This arrangement eliminates the need for the user to sort out image data, thus further facilitating the transfer of image data and saving the user much labor.

The system also may be provided with a storage place judging means to judge in which an image data selected by the user is stored, in the image management server or in the image management terminal so that a control instruction for the selected image data is forwarded or executed on the basis of the judgement by the storage place judging means.

Under that arrangement, there is no need for the user to learn new operating procedures when a switchover is made from the standalone image management system to the server-client image management system, because the user can operate from the same interface.

The system also may be arranged this way. When image data or management information stored in the image management server is given additional information or renewed, a renewal information preparation means prepares renewal information showing the details of the renewal, and a mail sending means sends the renewal information by electronic mail to specific users.

Under that arrangement, the users other than the user who changed image data or management information can immediately get renewal information, too.

It is noted that the image management terminal and the image management server may be offered as computer while the respective means provided in the image management terminal and the image management server, that is, the switchover control means, switchover image registration means, storage place judging means, renewal information preparation means, mail sending means etc. may be offered as programs which are read and executed by CPU.

### BRIEF DESCRIPTION OF THE DRAWINGS

FIG. 1 is a schematic block diagram of an image management system according to the present invention.

FIG. 2A shows examples of the server tables.

FIG. 2B shows examples of the server tables.

FIG. 3A shows examples of the terminal tables.

FIG. 3B shows examples of the terminal tables.

FIG. 4 is an example of the user interface in the standalone image management system.

FIG. 5 is an example of the user interface in the server-client image management system.

FIG. 6 is a flow chart showing procedures for server registration and package server registration.

FIG. 7 is a flow chart showing procedures for allocating instructions between the image management server and the image management terminal.

### DESCRIPTION OF THE PREFERRED EMBODIMENTS

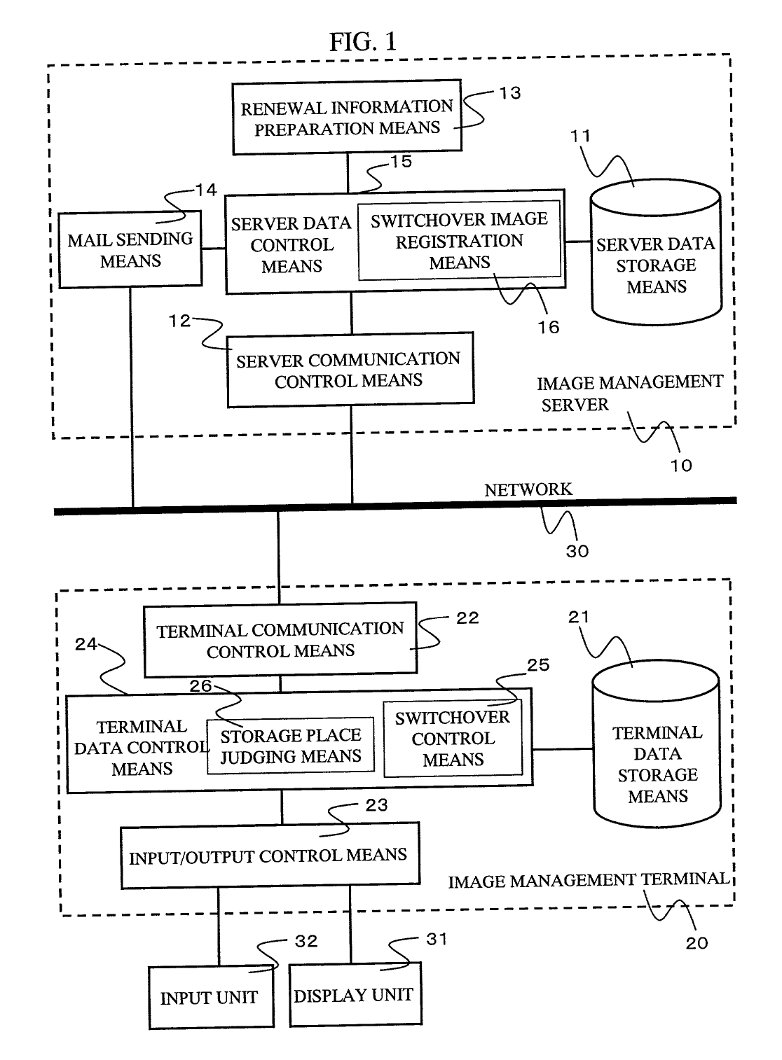

An embodiment of the present invention will now be described with reference to the accompanying drawings. It is to be understood that the following embodiment is an example embodying the present invention and does not limit the technical scope of the invention. FIG. 1 is a schematic block diagram of an image management system according to the present invention.

In FIG. 1, an image management server 10 is an unit on the server side of a server-client image management system and is formed of a server data storage means 11, a server communication control means 12, a renewal information preparation means 13, a mail sending means 14 and a server data control means 15.

An image management terminal 20 is a unit on the client side in the server-client image management system or forms a standalone image management system and is made up of a terminal data storage means 21, a terminal communication control means 22, an input/output control means 23 and a terminal data control means 24. To the image management terminal 20 are connected an input unit 32 such as the key board and pointing device and a display unit 31 such as a display. The image management server 10 and the image management terminal 20 are communicably connected to each other via a network 30 such as the local area network (LAN) and the wide area network (WAN), the Internet or telephone circuit network. The procedures by the respective means will be described in detail in due order.

[Data stored in memory means]

Prior to describing the procedures by the respective means in the image management server 10 and the image management terminal 20, the various data stored in server data storage means 11 and terminal data storage means 21 will first be explained. It is noted that the following various data are for the image management system to function but all the data are not required. It will be sufficient if only the data necessary for the image management system the user aims at is available.

Now, server data storage means 11 and terminal data storage means 21 store image data or an object for management. The form of files for the image data is not restrictive in particular. The conventional file formats such as, for example, JPEG (Joint Photographic Experts Group), GIF (graphic interchange format) and TIFF (Tagged Image File Format) are possible to handle.

Furthermore, server data storage means 11 and terminal data storage means 21 store information for management of the image data or management information in addition to the image data. The management information is stored in tables prepared in data base, for example, but may be stored as individual files. Here, one record in the table is to form one management information for one image data.

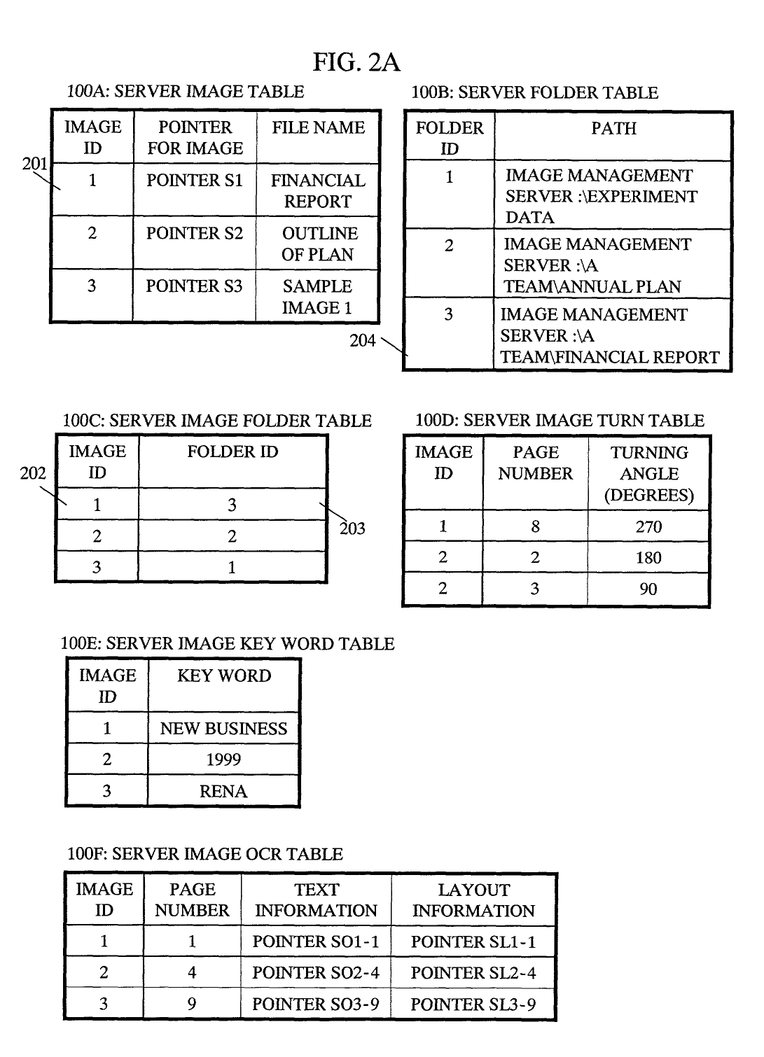

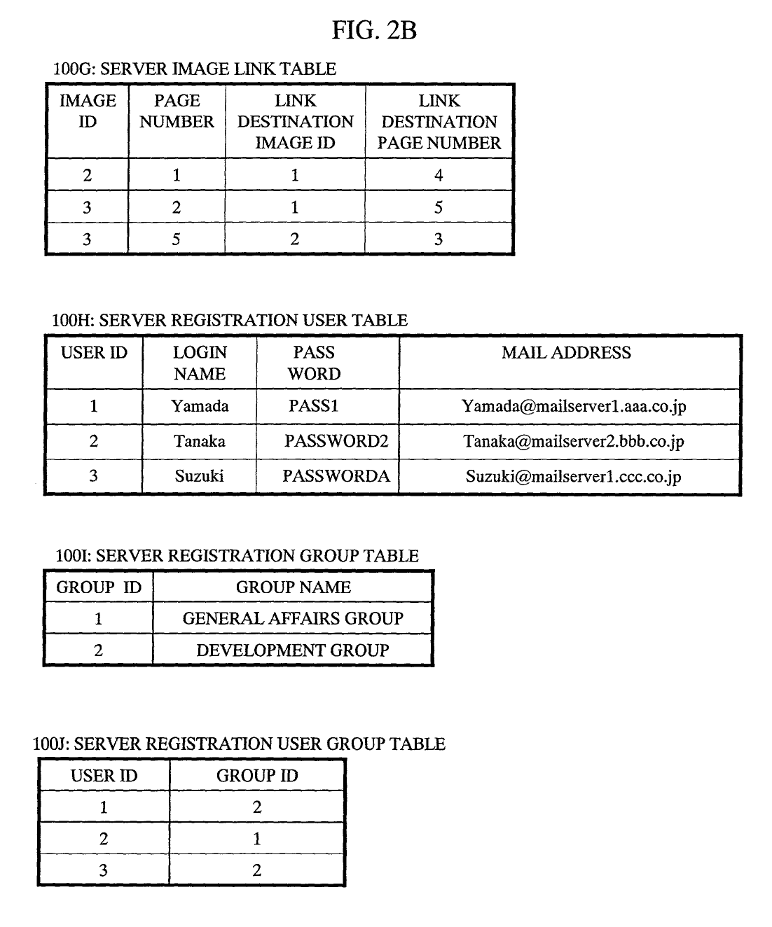

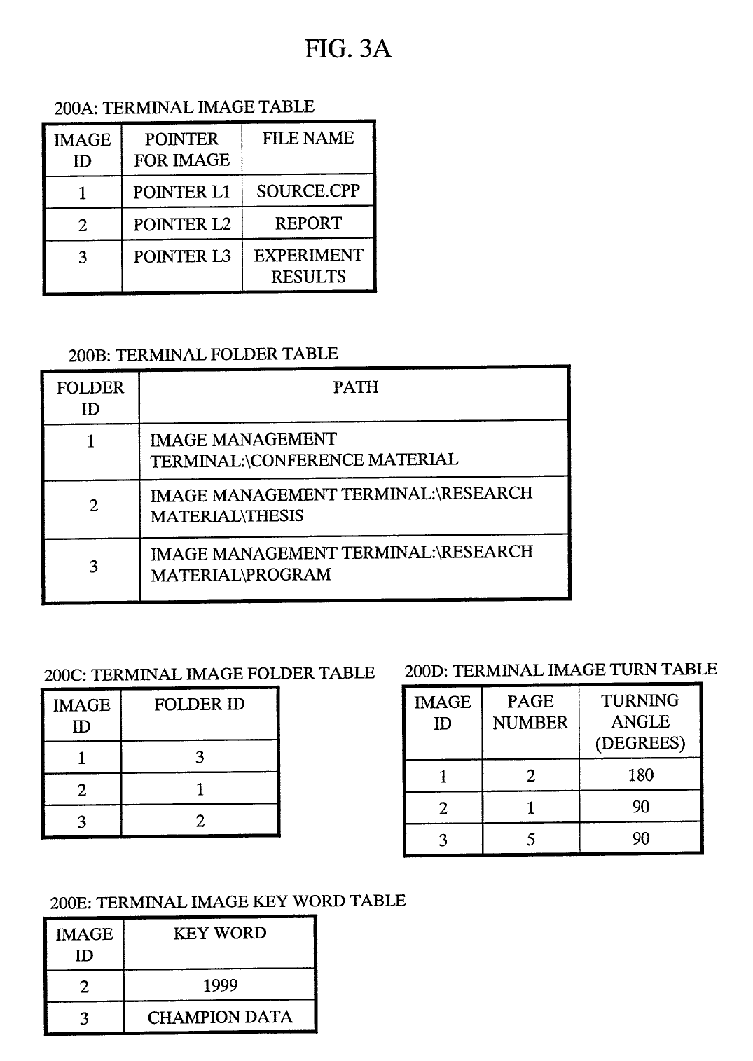

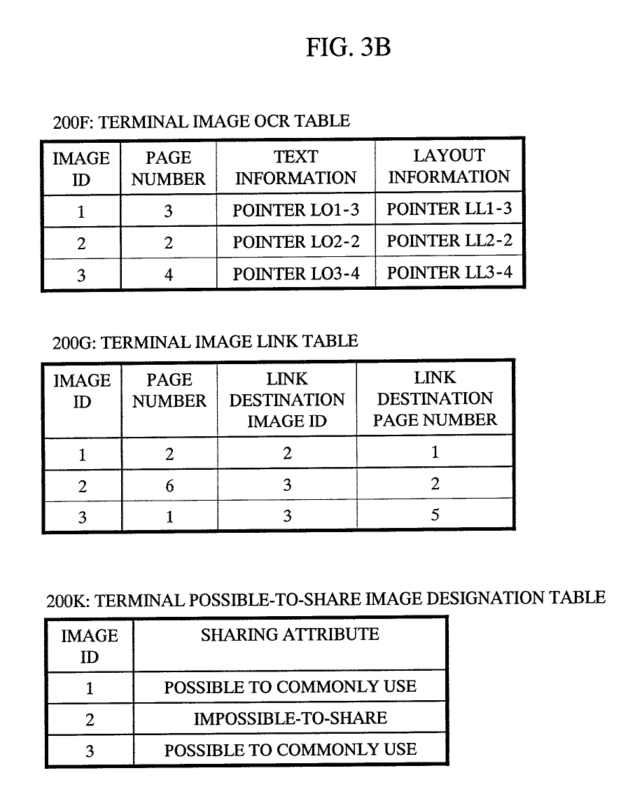

As concrete examples of the management information, server image management information is shown in tables 100a to 100j in FIG. 2A and FIG. 2B. Terminal image management information is shown in tables 200a to 200g and 200k in FIG. 3A and FIG. 3B.

Server image table 100a and terminal image table 200a shown in FIG. 2A and FIG. 3A store image ID's and the pointers for image data as well as file names with those kinds of information related to each other. The term “image ID's” as used herein are numbers given to image data in order of registering with the image management server 10 and the image management terminal 20, for example. In other words, the image ID is information that can specify a specific data. The pointer for image data is information that indicates the position where a specific image data is stored in the server data storage means 11 or the terminal data storage means 21. That is, the pointer can show a memory area where a specific image data corresponding to the pointer is stored. The image file name is a title given by the user, for example.

Next, a server folder table 100b and a terminal folder table 200b store folder ID's and folder paths (storage place) with those two kinds of information related to each other. The folder ID's are numbers given in order of preparing the folders to classify the images, for example, in the image management server 10 or the image management terminal 20. That is, the folder ID is information that indicates a folder where image data is stored.

A server image folder table 100c and a terminal image folder table 200c store the image ID's and folder ID's with those two kinds of information related to each other. The table can specify folders where images are stored. For example, the image data of image ID “1” (201) shown in the server image table 100a and image ID “1” (202) in the server image folder table 100c lead to folder ID “3” (203). Referring to folder ID “3” (204) in server folder table 100b can decide that the storage place (path) of image data “financial report” is “image management server:\Ateam\financial report.”

A server image turn table 100d and a terminal image turn table 200d store the ID's, page numbers and turning angles with those kinds of information related to each other. When the respective pages of image data are displayed or printed, the angle by which the image data is turned is determined on the basis of the image turn table. The respective pages are pages at which the respective image data are displayed when an image format is utilized in which a plurality of image data can be stored in a file such as, for example, image data of TIFF.

Next, a server image key word table 100e and a terminal image key word table 200e store the image ID's and key words with those two kinds of information related to each other. The key word is a character string for retrieval of image data. Specific image data can be retrieved using a character string associated with image data by the server image key word table 100e and the terminal image key word table 200e.

Next, a server image OCR table 100f and a terminal image OCR table 200f store image ID's, page numbers, text information and layout information with those kinds of information related to each other. The layout information is information obtained by performing layout recognition on image data, indicating the kinds, positions etc. of the unit information with photos, letters and characters, ruled lines etc. contained in the image data as unit information. The layout information is utilized in converting the image data into an electronic document. The text information is obtained by performing character recognition (OCR) on the area judged as character area by the layout recognition. With those kinds of information related to or associated with image data, it is possible to retrieve image data by full-text retrieval or to electronize image data. The text information and layout information are given as pointer for the storage area of the information.

Next, a server image link table 100g and a terminal image folder link 200g store image ID's, page numbers, link destination image ID's and link destination page numbers with those kinds of information related to each other. The link destination image ID is an image ID for an image data other than, but related to, the original or source image data. The link destination page number is information that, in case the link destination image data is made up of a plurality of pages, indicates specific image data out of a plurality of pages of the image data. From a specific page of certain data, it is possible to refer to other pages of the same image data or some other data using the server image link table 100g and the terminal image link table 200g.

A server registration user table 100h stores user ID's, login names, passwords and mail addresses with those kinds of information related to each other so as to manage information on registered users who can use the image management system in the image management server 10. The user ID's are unique numbers given in order of registering users with the image management server 10. The login name and the password are information that is used for authentication when the user is to be connected to the image management server 10. The mail address is an electronic mail address at which, in case image data is renewed, for example, that information indicating the renewal is sent. Details of the mail address will be described later.

Next, a server registration group table 100i stores group ID's and group names with those kinds of information related to each other. The group ID's are unique numbers of the respective groups given in order of forming groups in the image management server 10.

A server registration user group table 100j stores user ID's and group ID's with those kinds of information related to each other. From this table, it is possible to specify groups to which the registered users belong. One user can belong to a plurality of groups.

A terminal possible-to-share image designation table 200k stores image ID's and sharing attributes with those kinds of information related to each other. When a user registers image data with terminal possible-to-share image designation table 200k in the image management terminal 20, for example, the sharing attribute can be set to “possible-to-share” or “impossible-to-share.” As a result, this information is useful in sorting out the respective image data stored in the terminal data storage means 21 that can be transferred to the image management server, because it is possible to indicate in advance whether image data can be registered with server data storage means 11 and shared.

The server registration user table 100h, the server registration group table 100i and the server registration user group table 100j are provided only in the image management server 10. The terminal possible-to-share image designation table 200k is necessary only at the image management terminal 20 in a switchover to the server-client image management system and is a table provided only in the image management terminal 20.

As set forth above, if some or all the formats for management information stored in the image management server 10 are made identical with those management information stored in the image management terminal 20 and there are provided switchover control means for transferring management information and switchover image registration means, it will be easy to switch from the standalone image management system to the server-client image management system and it will be possible to make the user interface common.

[Procedures for operation of the image management system as a standalone image management system]

Next, there will be explained procedures for operation of the image management system as a standalone image management system. It is noted that the standalone image management system is generally utilized as prelude before introduction of the server-client image management system, for example. Therefore, in case the image management system is operated as a standalone image management system, the image management server 10 is not always required.

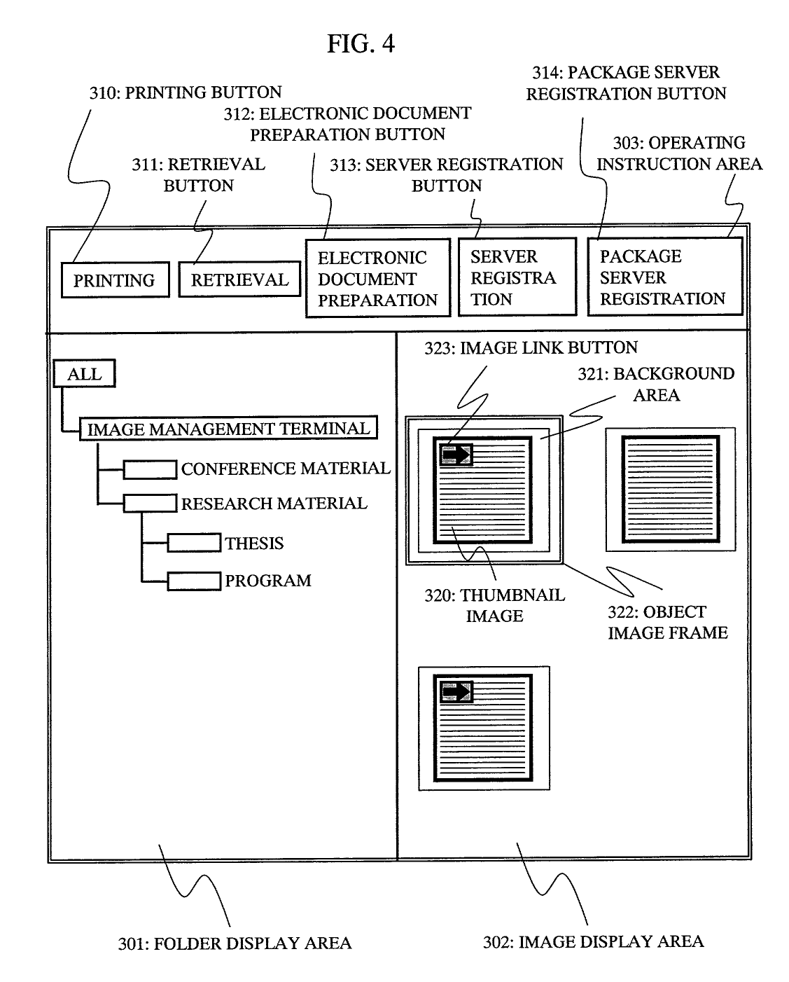

First, shown in FIG. 4 is an example of the user interface for handling image data in case the image management system operates as a standalone image management system.

In FIG. 4, the folder display area 301 of the user interface in the standalone image management system displays information of the folders in a tree structure—the folders registered with the terminal folder table 200b. The image display area 302 displays image data within a selected folder in the form of thumbnail. The display of the folder information, thumbnail of image data etc. is effected when terminal data control means 24 acquires management information on the display from the terminal data storage means 21 and gives the input/output control means 23 an instruction to make a display on the basis of the management information.

Furthermore, an operating instruction area 303 has operating instruction buttons disposed for various operations for image data and management information. Here are some examples of operating instruction buttons.

a) A printing button 310 to give an instruction to print an image selected from the images displayed on the image display area 302, the image selected through the input unit 32.

b) A retrieval button 311 to conduct image retrieval on the basis of text information, that is, the key word or the results of character recognition.

c) An electronic document preparation button 312 to re-arrange an electronic document from the text information of the OCR results and layout information.

d) A server registration button 313 to register with the server data storage means 11 of the image management server 10 management information as well as image data selected by the user from among the images stored in the terminal data storage means 21.

e) A package server registration button 314 to register with the server data storage means 11 of the image management server 10 all the image data with the sharing attribute “possible-to-share” out of the image data stored in the terminal data storage means 21.

Next, there will now be described the process after the user selects specific image data and presses the operating instruction buttons.

First, the user, who wants to use various functions to perform, that is, such procedures as registration and renewal offered by the buttons, selects image data using the input unit 32, the image data displayed by the display unit 31. Then, the user presses a proper button among operating instruction buttons 310 to 314 to input an instruction for processing the selected image data, that is, an operating instruction. The operating instruction may be directed to the image data and management information stored in the terminal data storage means 21.

Inputted through the input unit 32, the operating instruction is sent to the terminal data control means 24 through the input/output control means 23 of the image management terminal 20. Here, because the storage destination of object image data or management information for the operating instruction is terminal data storage means 21, terminal data control means 24 performs procedures for image data or management information stored in terminal data storage means 21, that is, displaying, registration, renewal etc. of image data or management information according to the operating instruction.

Now, when the operating instruction is for display, the following procedures will be followed. The display operating instruction is not carried out when the operating button is selected. When a specific folder is selected in the folder display area, for example, the following procedure will be performed.

First, the terminal data control means 24 refers to the terminal folder table 200b and specifies the folder ID for the selected folder. In this case, image data stored in the folder indicated by the folder ID is specified by the image ID corresponding to the folder ID shown in the terminal image folder table 200c. Then, the terminal data control means 24 reads out image data with the image ID using a pointer specified from the terminal image table 200a and also acquires the file name of the image data.

Next, terminal data control means 24 acquires the image data and management information stored in the respective tables 200a to 200k, and then sends the image data and management information to input/output control means 23. Receiving the image data and the management information, the input/output control means 23 output-controls the image data in a suitable form on the basis of the management information and sends the image data to the display unit 31. The display unit 31 displays the image data output-controlled in the suitable form on a display, for example.

In FIG. 4, the image data is displayed in the image display area 302 as a thumbnail image 320. Here, turning angle information for displaying the respective thumbnail images, for example, can be acquired by the terminal data control means 24 referring to the terminal image turn table 200d. That is, on the basis of the acquired turning angle (management information), input/output control means 23 displays the image data in a turned state. In other words, the display of image data is controlled on the basis of the management information.

On the backgrounds of the respective displayed thumbnail images, a background area 321 is displayed. The background areas 321 of the images stored in terminal data storage means 21 are displayed in blue, for example. The blue color means that the image data is stored in terminal data storage means 21.

In addition, an object image frame 322 is displayed around the image selected as object of operation or object image. Furthermore, in case link information is stored in the terminal image link table 200g, an image link button 323 is displayed on the thumbnail image 320 having the link information. Here, if the image link button 323 is pressed through the input unit 32, the display is switched so that the image at the link destination becomes an object image.

Next, there will be explained the concrete operation of the system when the operating instruction buttons in the operating instruction area 303 are pressed through the input unit 32.

In case the printing button 310 is pressed, the operating instruction is received by terminal data control means 24. Then, terminal data control means 24 refers to the terminal image turn table 200d, specifies turning angle information from the image ID of the object image and prints out the image data turned according to the stored turning angle information.

In case the retrieval button 311 is pressed, the operating instruction is received by terminal data control means 24 through input/output control means 23. Receiving the operating instruction, the terminal data control means 24 displays an input box for the retrieval character string on the display unit 31 through input/output control means 23.

If the user inputs a character string for retrieval in the input box through the input unit 32, the character string is sent to input/output control means 23. Then, if terminal data control means 24 checks the character strings on the terminal image key word table 200e to see whether there is a key word identical with the character string inputted by the user. If a key word is found that is identical with the character string, only the image data specified from the terminal image table 200a on the basis of the image ID corresponding to the image data are displayed side by side, for example, on the display unit 31. Key word retrieval may be performed by using text information obtained through OCR of image data. In this case, text information stored in the area indicated by the pointer for the text information of the terminal image OCR table 200f is checked, and only the images where the character string is found identical with part of the text information are displayed side by side, for example.

If the electronic document preparation button 312 is pressed, the operating instruction is received by terminal data control means 24 through input/output control means 23. Then, terminal data control means 24 refers to the terminal image OCR table 200f, specifies text information and layout information of the OCR results of the object image, and re-arrange the electronic document from this text information and layout information.

Such are general functions offered by the standalone image management system. There are various other functions, but the purpose of the present invention is not to explain all the functions of the image management system and other functions will not be explained.

As set forth above, the image management terminal 20 can work as a standalone image management system.

[Switchover to the server-client image management system]

In the following, there will be explained the procedures involving the switchover from the standalone image management system to the server-client image management system. For the switchover, needless to say, the user has to have an image management server 10.

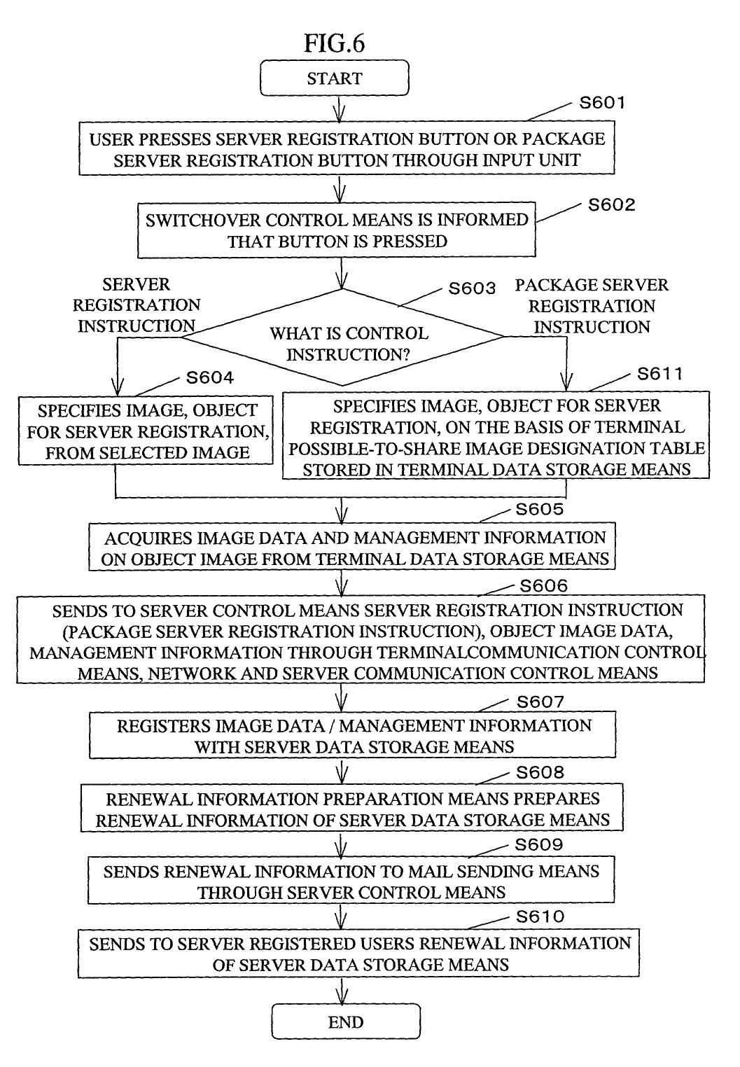

In a switchover from the standalone image management system to the server-client image management system, the user selects image data (to be laid open) to be shared with other users through the user interface shown in FIG. 4. Then, the user presses a server registration button 313 shown on the display unit 31 using the input unit 32 (FIG. 6:S 601).

If the user presses the server registration button 313, switchover control means 25 in the terminal data control means 24 receives information that the registration button is pressed, and specifies an image ID of image data to be registered with the image management server 10 on the basis of the currently selected image, that is, the object image (FIG. 6, Steps S 602→S 604).

Next, the switchover control means 25 acquires the image data of the object image from terminal data storage means 21 and also management information related to the object image from the respective tables of terminal data storage means 21 (FIG. 6, Step S 605). The management information to be acquired here is the file name, folder information, turning angle information, key word information, text information and layout information of OCR results, and link information.

The file name is specified from the terminal image table 200a on the basis of the image ID of the object image.

The folder information is obtained this way. First, the folder ID of the folder where the image data is placed is specified on the basis of the image ID of the object image from the terminal image folder table 200c. Then on the basis of the folder ID, the path of the folder is specified from the terminal folder table 200b. Thus, the folder information is obtained.

The turning angle information is specified along with the page number from the terminal image turn table 200d on the basis of the image ID of the object image.

The key word information is specified from the terminal image key word table 200e on the basis of the image ID of the object image.

The text information and layout information of OCR results are specified along with the page number from the terminal image OCR table 200f on the basis of the image ID of the object image.

The image data and management information thus acquired are sent from the switchover control means 25 to the terminal communication control means 22. At the same time, switchover control means 25 instructs terminal communication control means 22 to send to the image management server 10 a server registration instruction to the effect that the object image should be registered. Upon receiving the instruction, the terminal communication control means 22 sends to the image management server 10 the image data of the object image, management information and the server registration instruction.

Then, server communication control means 12 in the image management server 10 receives the image data and management information along with the server registration instruction, and sends them to server data control means 15 (FIG. 6, Step S 606).

Next, switchover image registration means 16 in server data control means 15 registers the image data of the object image and management information with server data storage means 11 according to the server registration instruction (FIG. 6, Step S 607).

The registration of the image data and registration information is carried out by switchover image registration means 16 in the following order, for example. That is, the image data of the object image received is stored in server data storage means 11. Then, the pointer information showing the storage destination is registered with the server image table 100a along with a new image ID given at switchover image registration means 16 and a file name sent in from the image management terminal. In addition, the turning angle information sent in from the image management terminal and the page number information are stored in the server image turn table 100d along with the new image ID.

Furthermore, the text information and layout information of OCR results are stored in server data storage means 11, and the pointer information showing the storage destination thereof and page number are stored in the server image OCR table 100f along with the new image ID. In addition, key word information is stored in the server image key word table 100e along with the new image ID.

Folder information is processed as will be explained in the following.

That is, in case a path matching with the folder information sent in is found in the server folder table 100b, the folder ID is registered with the server image folder table 100c along with the new image ID.

In case no path matching with the folder information sent in is not present in the server folder table 100b, the path for the folder information sent in is registered with the server folder table 100b along with the new folder ID, and the new folder ID is registered with the server image folder table 100c along with the new image ID.

But in the server-client image management system, a plurality of users can register images with the image management server 10. Therefore, in case different users manage images in the folders of the same path at different terminals and if image data is registered with the image management server 10 in that way, it means that images registered by a plurality of users will be present in the same folder in the image management server 10. If image data of different users need to be placed in different folders in the image management server 10, that can be achieved by using the login name to the image management server 10 used in the authentication of the user, for example, in part of the path information of the folder.

In other words, it is a method in which the name produced by adding the login name of the registered user to the folder name at the end of the path of the folder where the object image is placed in terminal data storage means 21 is used as the name of the folder on the server. If, for example, a user with a login name “USER1” has an object image in a folder named “IMAGE CONTROL TERMINAL:\CONFERENCE MATERIAL” in terminal data storage means 21, it means that on the server, the object image is registered with a folder named “IMAGE CONTROL SERVER: \CONFERENCE MATERIAL_USER1.” In another method, a folder having a user's login name is added on top of the folder name at the highest hierarchical level of the folder where the object image is placed in terminal data storage means 21. In other words, in case a user having a login name “USER1” has entered the object image in a folder named “IMAGE CONTROL TERMINAL:\CONFERENCE MATERIAL,” it means that on the image management server, the object image is registered in a folder called “IMAGE CONTROL SERVER:\USER1\CONFERENCE MATERIAL.”

As to link information, only in case images at the link source and the link destination are selected as object image at a time and the server registration button 313 is pressed, the link information is to be held even after being registered in server data storage means 11. In other words, like other management information, switchover control means 25 specifies the image ID at the link destination and the page number at the link destination along with the page number of the link source from terminal image link table 200g on the basis of the image ID of the object image. Then, it means that when switchover image registration means 16 stores those kinds of information in server data storage means 11, page information at the link source and the link destination is registered with the server image link table 100g along with the new image ID's given to the image at the link source and the image at the link destination. In transferring one file which can store a plurality of image data (lilke TIFF), link information is held even in case the image data at the link source and the image data at the link destination is in the same file.

Such are procedures taken in transferring one or a plurality of image data from the image management terminal 20 to the image management server 10.

As set forth above, if part or the whole of management information to be stored in the image management server and management information to be stored in the image management terminal is arranged in the same way, and if there are provided switchover control means to transfer management information and the switchover image registration means, images can be transferred from the image management terminal to the image management server easily without registering image data again.

In the transfer, the user has to select image data when image data the user hopes to transfer is transferred to the image management server 10. It is troublesome if there are a large number of image data. Therefore, there is provided the terminal possible-to-share image designation table 200k so that package transfer may be possible.

That is, if the user issues an operating instruction via the package server registration button 314, switchover control means 25 acquires the image ID of image data with the sharing attribute “POSSIBLE TO SHARE” from the terminal possible-to-share image designation table 200k (FIG. 6, Steps S 603→S 611). Then, the image data and the management information having the image ID acquired here are registered with the image management server 10. It is noted that registration of the image data and management information with the image management server 10 can be effected in the same procedure as in issuing an operating instruction via the server registration button 313 (FIG. 6, Steps S 605→S 607).

As set forth above, if there is provided terminal possible-to-share image designation table 200k so as to make it possible to transfer specific image data alone in the lump, image data can be transferred without imposing a burden on the user.

Furthermore, the system can be so arranged that the user can freely select image data to transfer to the server, and data not to share that the user does not want others to see can be stored in the terminal data storage means 21 while data possible-to-share that can been seen by other users, too, can be stored in the server data storage means 11. In this case, there is no need of complicated control on the access to image data stored in the image management server 10, thus making the operation easy. In addition, data not possible-to-share are not even registered with the image management server 10, thus providing strict security.

[Procedures of the system as server-client image management system]

Next, there will be explained the form of operation after switchover from the standalone image management system to the server-client image management system, that is, procedures in case where the image management system works as a server-client image management system.

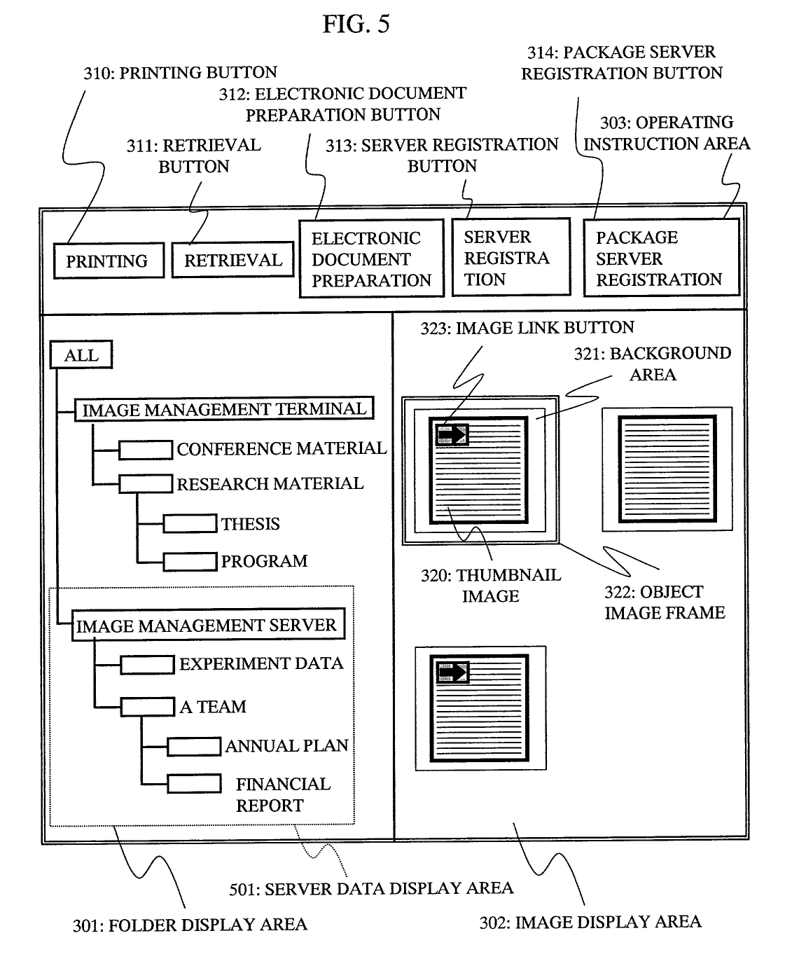

First, FIG. 5 shows an example of the user interface for handling image data in case the system operates as a server-client image management system.

In FIG. 5, the folder display area 301 of the user interface in the server-client image management system displays information on the folders registered with the server folder table 100b in addition to the terminal folder table 200b in a tree structure (the dotted line portion in FIG. 5: a server data display area 501). The user interface described above is a user interface displayed in the image management terminal 20, for example. In the image display area 302, the image data within the selected folder is displayed in the form of thumbnail as in the standalone image management system. But the background area 321 of the image stored in the server data storage means 11 is shown in red, for example. Here, the red color indicates that the image data is stored in the server data storage means 11. By the red color and the blue color mentioned earlier, the user can judge the storage place of the image data at a glance. As an alternative to the color display, different patterns may be used on the background area to indicate the storage area.

Next, there will be explained the basic operation process of the server-client image management system, that is, the process that when the user inputs an instruction for image data or management information from the input unit 32, the image management terminal 20 displays image data or management information from server data storage means 11 or terminal data storage means 21. Hereinafter, both the image data and management information will be called object data.

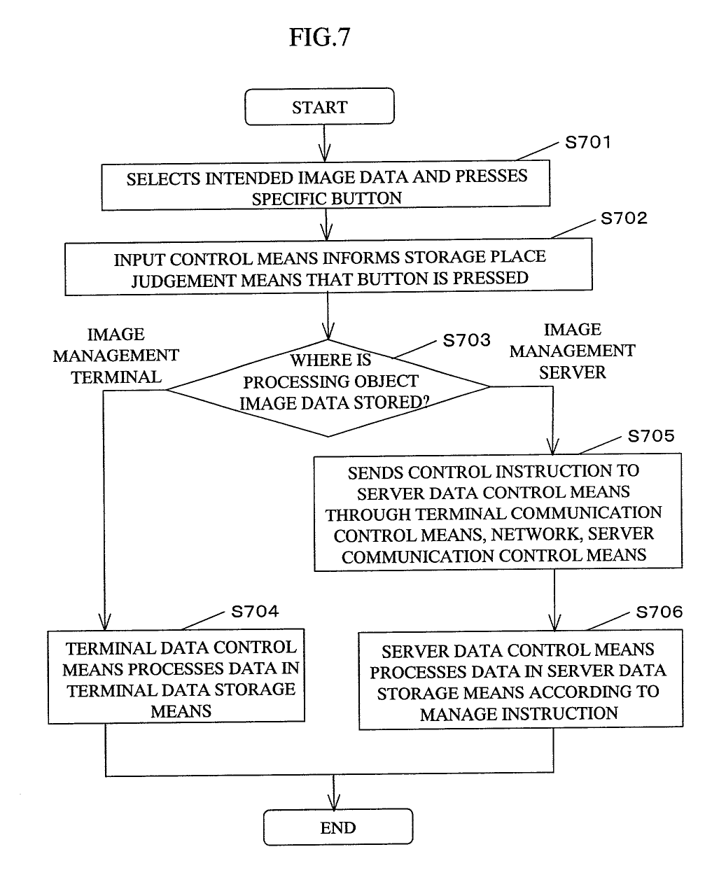

First, the user, who wants to perform procedures such as display, registration, renewal etc. of image data, selects an intended image data through the interface shown in FIG. 5, for example, and presses buttons for the needed procedures to issue an instruction for specific procedures to be performed. The procedures up to this point are the same as those for the standalone image management system (FIG. 7, Step S 701).

The operating instruction in the server-client image management system can be issued for image data stored both in server data storage means 11 and terminal data storage means 21.

If an operating instruction is inputted from the input unit 32, the operating instruction is sent to storage place judging means 26 in the terminal data control means 24 through input/output control means 23 (FIG. 7, Step S 702). In FIG. 1, storage place judging means 26 is within terminal data control means 24. Alternatively, storage place judging means 26 may be provided independently.

Then, storage place judging means 26 judges whether the operating instruction is directed to image data stored in server data storage means 11 or in terminal data storage means 21 (FIG. 7, Step S 703). Alternatively, the judgement may be made on the basis of information on the folder selected in the user interface or image ID, or by referring to terminal data storage means 21 to see if image data is present in the terminal data storage means 21.

Here, if the storage place judging means 26 judges that the storage destination of image data or an object for the operating instruction is terminal data storage means 21, terminal data control means 24 carries out procedures for the object data stored in terminal data storage means 21—the procedures indicated in the operating instruction, that is, display, registration, renewal etc. (FIG. 7, Steps S 703→S 704).

If, on the other hand, storage place judging means 26 finds that the storage destination of image data or the object for the operating instruction is server data storage means 11, terminal data control means 24 instructs terminal communication control means 22 to send (transfer) to the image management server 10 a control instruction to the effect that image data or management information should be displayed, registered, renewed or the like. Receiving the instruction, terminal communication control means 22 sends the control instruction according to that instruction.

The control instruction is received by server communication control means 12 through the network 30 and transferred to server data control means 15 (FIG. 7, Steps S 703→S 705).

Receiving the control instruction, server data control means 15 then performs the procedures for the object data stored in server data storage means 11—the procedures according to the control instruction (FIG. 7, Step S 706).

To take an example where the control instruction is to display image data, server data control means 15 sends the acquired object data to server communication control means 12, instructing that the object data should be sent to the image management terminal 20. Then, through the network 30, the server communication control means 12 sends to terminal communication control means 22 in the image management terminal 20 the object data received from the server data control means 15.

Receiving the object data, terminal communication control means 22 sends the object data to terminal data control means 24. Then terminal data control means 24 forwards the object data to input/output control means 23. The input/output control means 23 in turn controls to output the received object data in a suitable form on the basis of management information and sends the data to the display unit 31. The display unit 31 displays the image data—controlled and outputted in a suitable form—on the display or the like.

Such are basic sending and receiving procedures between the image management terminal 20 and the image management server 10 in the image management system. In the server-client image management system, an example of displaying image data is described. The server-client image management system is also identical with the standalone image management system in that management information is referred to before image data is processed in each procedure such as retrieval of image data. Here, since most of the management information formats for management of image data stored in the image management server 10 are made identical with the corresponding formats for management of image data stored in the image management terminal 20, it is possible to process image data merely by judging the storage place in the server-client image management system as in the standalone image management system.

As set forth above, an instruction for image data to be stored in the image management server 10 and the image management terminal 20 is inputted from the common user interface and at the same time the storage place for the image data, an object of the instruction, is automatically judged by storage place judging means 26. Thus, when a switchover is made from the standalone image management system to the server-client image management system, the user does not have to learn new operating procedures.

Furthermore, since most of the management information formats for management of image data stored in the image management server 10 are made identical with the corresponding formats for management of image data stored in the image management terminal 20, the image management terminal is easy to operate as terminal for the standalone image management system and the server-client image management system. But the management information does not always have to be identical if the information can be converted between the form of the image management terminal 20 and the image management server 10.

[User authentication in the image management server]

In case the system operates as a server-client image management system and user authentication is required when the system is used, input/output control means 23 displays an authentication box on the display unit 31, inquiring the login name and pass word of the user. Here, the login name and pass word are inputted by the user and transferred from input/output control means 23 to terminal data control means 24. Then, terminal data control means 24 instructs terminal communication control means 22 to send an authentication confirmation instruction (an example of the control instruction) to the image management server 10. Terminal communication control means 22 sends the authentication confirmation instruction to the image management server 10 along with the login name and pass word.

The authentication confirmation instruction is received by server communication control means 12 and forwarded to server data control means 15. The server data control means 15 checks the server registration user table 100h to see whether there is a registered user identical with the received login name and pass word. In case such a user is found, connection to the image management server 10 is permitted. Once the connection to the image management server 10 is permitted, the login name of the registered user connected to the image management server 10 will be maintained in the terminal data control means 24 until the connection is cut.

[Electronic mail]

As another function of the image management server 10, the following function may be cited. That is, in case some renewal (step shown in FIG. 6:S 607, for example) or addition is made to image data or management information stored in the server data storage means 11, details of the renewal will be automatically recorded and stored in renewal information preparation means 13 (FIG. 6, Step S 608). Renewal information to be prepared here includes registration or erasure of image data and listing of items changed or details of changes in management information.

The renewal information is sent to mail sending means 14 by server data control means 15 (FIG. 6, Step S 609). In this case, server data control means 15 also forwards to mail sending means 14 the mail addresses of the users registered on the server registration user table 100h of server data storage means 11. Then, mail sending means 14 sends electronic mail describing renewal information at the mail addresses (FIG. 6, Step S 610).

As described, renewal information is sent to the users by electronic mail, whereby the users can know that image data or management information is renewed and get renewal information immediately.

The users to whom electronic mail is sent can include all the users registered in the image management server 10. Sending of electronic mail may also be limited to the users belonging to the same group as the user who worked on image data or management information stored in server data storage means 11.

In case electronic mail is to be sent to all the users registered with the image management server 10, the mail addresses of all the users registered on the server registration user table 100h are acquired and sent to mail sending means 14.

In case electronic mail is sent to the users belonging to the same group as the user who renewed image data or management information, on the other hand, the following procedure will be performed. On the basis of the server registration user group table 100j, server data control means 15 specifies the ID of the group—to which the users belong—from the user ID of the user who renewed data. Then, the user ID's of the users belonging to the group ID are specified. From the user ID's, the mail addresses are acquired on the basis of information of the server registration user table 100h and forwarded to mail sending means 14.

Each time the server data is renewed, renewal information may be prepared and sent by electronic mail. The respective users could get renewal information about server data storage means 11 quickly. As an alternative to that, the following method may be adopted. That is, renewals of server data storage means 11 are entered in a list at renewal information preparation means 13 for a specific period of time. After the specific period of time, the list of renewals made is sent to users by electronic mail. That reduces the number of electronic mailings, thus reducing the load on the network and presenting the other users with renewal information in the form of an easy-to-understand list.

As set forth above, some or all the formats for management information stored in the image management server are made identical with those management information stored in the image management terminal and there are provided switchover control means for transferring management information and switchover image registration means, thus substantially reducing the labor needed for switchover from the image management terminal to the image management server, that is, switchover from the standalone image management system to the server-client image management system.

In addition, there is provided a terminal possible-to-share image designation table that permits package transfer of only specific image data, thus further making it easy to transfer image data without imposing a burden on the user.

Furthermore, the user can freely select image data to transfer to the server. Data not possible-to-share, that is, data the user does not want others to see are stored in terminal data storage means 21, while data possible-to-share or data other users can see are stored in server data storage means 11. In this case, there is no need of complicated control on access to the respective image data stored in image management server 10, facilitating the handling of image data. Furthermore, data not possible-to-share are not even registered in the image management server, providing strict security.

In addition, instructions for image data to be stored in the image management server and the image management terminal are inputted from a common user interface and at the same time the storage place for image data or an object for an instruction is automatically located by storage place judging means. Thus, the user does not have to learn new operating procedures when a switchover is made from the standalone image management system to the server-client image management system.

Furthermore, most of the management information formats for management of image data stored in the image management server 10 are made identical with the corresponding formats for management of image data stored in the image management terminal 20. Therefore, the image management terminal can serve as a standalone image management system and server-client image management system.

Another feature is that in case some changes are made in image data or management information stored in the image management server, this renewal information will be automatically given to the registered users of the image management server by electronic mail. Because of provision of this function, the other users, too, can get renewal information right away.

What is claimed is:

1. An image management system which comprises image management terminals and an image management server and wherein electronized image data are managed using management information for management of said image data,
said image management terminals provided with switchover control means for sending to said image management server said image data and said management information according to instructions from a user, said image data and said management information stored in said image management terminals, and
said image management server provided with switchover image registration means for registering with specific storage means said image data and said management information acquired from said image management terminals.

2. The image management system of claim 1 wherein
the management information stored in said image management terminal has sharing attribute information indicating whether image data corresponding to said management information should sent to the image management server, and
said switchover control means sends said image data and management information on the basis of said sharing attribute information.

3. The image management system of claim 1 or claim 2 wherein said image management terminal is provided with:
storage place judging means for judging in which image data selected by the user is stored, in said image management server or in the image management terminal, and
terminal data control means for forwarding or executing a control instruction for said selected image data on the basis of the judgement by the storage place judging means.

4. An image management system which comprises image management terminals and an image management server and wherein electronized image data are managed using management information for management of said image data,
said image management terminals storing said image data and said management information for the user operating said image management terminal alone to utilize,
said image management server storing said image data and said management information for a plurality of users to share, and
said image management terminal having terminal data control means for management of both the image data stored in the image management terminals and the image data stored in the image management server.

5. The image management system of claim 4 wherein in displaying said image data, said image management terminal distinguishably displays the image data stored in said image management server and the image data stored in said image management terminals.

6. The image management system of claim 5 wherein for said distinguishable display, different colors are used on the background area of said image data on the display screen.

7. The image management system of claim 5 wherein for said distinguishable display, different patterns are used on the background area of said image data on the display screen.

8. The image management system of claim 1 or claim 4 wherein said image management server further comprises:
renewal information preparation means for preparing renewal information showing the details of a renewal when the image data or management information stored in said image management server is given an addition or renewed, and
mail sending means for sending said renewal information to specific users by electronic mail.

9. The image management system of claim 8 wherein said image management server further holds information on the users classified into groups who use said image management server, and
said mail sending means sends said electronic mail to the users only who belong to the same group as the user who revised said image data or management information.

10. The image management system of claim 9 wherein said renewal information preparation means further prepares a renewal information list of renewals made for a specific period of time, and
said mail sending means sends said renewal information list.

11. The image management system of claim 1 or claim 4 wherein said management information includes at least one of the following:
key word information of image data corresponding to said management information,
link information to image data related to the image data corresponding to said management information,
text information obtained by optical character recognition (OCR) of image data corresponding to said management information,
layout information showing the kind and position of unit information included in image data corresponding to said management information,
turning angle information showing the turning angle of said image data when displaying or printing out image data corresponding to said management information, or
folder information for classifying and keeping image data corresponding to said management information.

12. A image management terminal wherein electronized image data are managed using management information for management of said image data, said terminal provided with switchover control means for sending to a specific image management server said image data and said management information according to instructions from the user, said image data and management information being stored.

13. The image management terminal of claim 12 wherein said management information includes sharing attribute information indicating whether the image data corresponding to said management information should sent to said image management server, and
said switchover control means sends said image data and management information on the basis of said sharing attribute information.

14. The image management terminal of claim 12 or claim 13 which comprises storage place judging means for judging in which the image data selected by the user is stored, in the image management server or in the image management terminal, and terminal data control means for forwarding or executing a control instruction for said selected image data according to the judgement by said storage place judging means.

15. An image management server for management of electronized image data using management information for management of said image data, said server comprising switchover image registration means for registering with specific storage means said image data and said management information acquired from a specific image management terminal.

16. An image management method for management of electronized image data using management information for management of said image data, said method comprising:
switchover step for sending to a specific image management server said image data and said management information stored in a specific image management terminal according to instructions from the user, and
switchover image registration step for registering with specific storage means said image data and said management information acquired from said image management terminal.

17. The image management method of claim 16 where said switchover step sends said image data and said management information on the basis of the sharing attribute information indicating whether the image data corresponding to said management information can be sent to said image management server, said sharing attribute information included in said management information.

18. A program for having an image management terminal—for management of electronized image data using management information for management of said image data—execute:
instruction receiving step for accepting instructions of the users, and
switchover step for sending to a specific image management server said image data and said management information stored in said image management terminal on the basis of said instruction receiving step.

19. The program of claim 18 wherein said switchover step further sends said image data and said management information on the basis of the sharing attribute information indicating whether the image data corresponding to said management information should sent to said image management server, said sharing attribute information included in said management information.
